(19) United States
(12) Patent Application Publication
(10) Pub. No.: US 2017/0097233 A1
(43) Pub. Date: Apr. 6, 2017

(54) METHOD FOR QUALIFICATION TESTING OF A TUBULAR CONNECTOR

(71) Applicant: SHELL OIL CO,PANY, Houston, TX (US)

(72) Inventors: Mark Michael SHUSTER, Voorburg (NL); Djurre Hans ZIJSLING, Rijswijk (NL); Egbert Jan VAN RIET, Rijswijk (NL); Henry Rihard PASARIBU, Rijswijk (NL); Willem Maarten VAN HAAFTEN, Rijswijk (NL)

(21) Appl. No.: 15/312,127

(22) PCT Filed: May 20, 2014
(86) PCT No.: PCT/EP2014/060285

§ 371 Date: Nov. 17, 2016

(51) Int. Cl. G01B 21/30; G01N 3/08; G01M 3/00

(52) U.S. Cl. CPC G01B 21/30; G01M 3/00; G01N 3/08; G01N 2203/0246

(57) ABSTRACT

The invention provides a method of selecting a threaded tubular connector for qualification testing, the method comprising the steps of providing a test specimen (34) provided with a test surface that exhibits comparable material properties and/or surface topology as the sealing surface on the connector, determining a parameter of the test surface relating to the sealing capability of the sealing surface; subjecting the test surface to a load, the load corresponding to a selected phase of a qualification test procedure for the tubular connector; removing the load; determining a variation of the parameter; and ceasing the qualification test procedure if the variation of the parameter indicates a reduction of the sealing capability of the sealing surfaces.

The present invention relates to a method for qualification testing of tubular connectors. The connectors typically are threaded connections of oil country tubular goods (OCTG), such as casing, drill pipe sections, and similar pipe sections. A multitude of such pipe sections may be connected to make up tubular strings for application in a wellbore, such as, for instance, casing strings or drill string.

OCTG tubular connectors of this type are generally used for applications such as casing, liner and production tubing and may generally be referred to as OCTG connections, or just connectors or connections.

Connectors for OCTG typically include at least a first connector member and a second connector member. The first connector member may be referred to as pin section, and the second connector member may be referred to as box section. The pin member may have a threaded outer surface and the box member may have a corresponding threaded inner surface allowing the pin member and box member to be connected.

Together, the pin and box sections can be made up to connect respective pipe sections. The connector sections have contact surfaces of varying quality, providing correspondingly different levels of sealing ability but also cost. Thus, a wide range of different quality connectors can be made, suitable for a wide range of downhole conditions and applications.

API (American Petroleum Institute) threaded connectors provide a range of commonly used types of connector which perform relatively well at relatively low cost. API connectors however may not always provide reliable gas-tight sealing. In view thereof the API threaded connectors are generally primarily used for liquid service applications, while more expensive premium connections are used for applications where gas-tight sealing is required. Gas-tight sealing may for instance be required for production tubing of gas wells, for high-temperature high-pressure wells (wherein downhole conditions may exceed for instance a temperature of 150 degree C. and/or a pressure of 300 bars), and/or for deep water wells (in water depths exceeding for instance 1 km).

In addition, for many oilfield applications it may be required that the connectors provide liquid-tight, or even gas-tight sealing, while also providing sufficient mechanical integrity to withstand internal and external loads that may be exerted on the connector during its lifetime. Premium connectors may be required to provide gas-tight sealing. Premium connectors typically comprise a metal-to-metal seal area to achieve the required gas-tight sealing capability.

In order to objectively determine whether new connector designs meet the required qualifications, the oil and gas industry has developed qualification protocols. For example ISO-13679 is a commonly used industry standard to assess the performance and quality of OCTG connectors.

Different applications may require (slightly) different connections, for instance due to varying wall thickness, threading, steel grade of the pipe material, pressure rating, required collapse or burst strength, etc. Before application in the field, every new connection must first pass one of these qualification protocols. An operator may require a multitude of new connections each year, which each have to be tested before they can be applied in the field. The applicant for instance may require a number, for instance in the order of 20 to 40, new connections per year for its operations, which each must pass a test to prove the connector qualifies the protocol. Due to the many different connectors, the relatively high cost per test procedure, and the possibility that connectors may fail the test requiring even more connectors to be tested, the total cost for connector testing per year may be, and typically is, considerable.

To qualify a proposed connector for a particular tube diameter, material and wall thickness, a number of test specimens—i.e. samples—will be prepared for each proposed connector. For instance about two to ten samples are made per connector design, for instance about five specimens. Respective specimens usually differ by geometry. Their geometries are for instance machined at various extreme combinations of machining tolerances in order to obtain test specimens with minimum and maximum interference fit of the metal-to-metal seal.

During the test procedure, each respective specimen is typically subjected to repeated make-up and break-out (assembly and disassembly) of the connector to investigate whether damage to the thread or to the metal-metal seal area occurs as a result of make-up or break-out. Thereafter, specimens may be subjected to axial load, internal or external pressure, and/or temperature cycling to investigate the effect on sealing performance. Limit load testing may also be part of the qualification procedure.

Typically, a connector design is used for a range of different tube sizes, wall thicknesses and materials. However, in order to qualify one connector design for such different tubes, it is often required to repeat the qualification test for a number of different combinations of wall thickness, diameter and material. A full qualification test is usually a time consuming and expensive process. Consequently, having to repeat the test procedure for each specific combination of dimensions and differing characteristics, in addition to the testing of multiple connector designs, is a considerable cost burden for drilling operations.

It is an object of the invention to provide a method to improve efficiency of selecting connectors for qualification testing.

The invention provides a A method for qualification testing of a tubular connector for a hydrocarbon fluid production application, the tubular connector comprising a sealing surface, the method comprising the steps of:
selecting a test surface representative of the sealing surface of the tubular connector;
selecting at least one surface parameter;
measuring the at least one surface parameter on the test surface;
assessing a sealing performance of the sealing surface based on the measured at least one parameter; and
deciding to cease qualification testing of the tubular connector if the assessment is unfavourable.

The method of the invention reduces the chance that connector designs will fail a qualification test, and thus limits testing costs and time and improves the efficiency of qualification testing. The method allows executing the qualification test of OCTG connectors according to approved industry standards, while reducing the required time and costs.

According to another aspect, the invention provides a method for qualification testing of a tubular connector for a hydrocarbon fluid production application, the method comprising the steps of:
providing at least two test samples of the tubular connector;
selecting a test surface on the at least two test samples;
selecting at least one surface parameter;
measuring the at least one surface parameter on the test surface of each of the at least two test samples;
assessing a sealing performance of the test surfaces of the at least two test samples based on the measured surface parameters of each of the at least two test samples;
selecting an initial test sample of the at least two test samples, the initial test sample having a test surface that is least likely to seal; and
commencing the qualification testing with the initial test sample.

According to yet another aspect, the invention provides a method of selecting a tubular connector for qualification testing for a hydrocarbon fluid production application, the connector including a first connector member and a second connector member being adapted to be engaged to each other whereby a first contact surface and a second contact surface of the first connector member and the second connector member respectively are in sealing contact with each other, the method comprising the steps of:
providing a test surface selected from one of said first contact surface and second contact surface,
determining at least one parameter of the test surface relating to the sealing capability of the contact surface;
subjecting the test surface to a load, the load corresponding to a selected phase of a qualification test procedure for the tubular connector;
removing the load;
determining a variation of the at least one parameter; and
ceasing the qualification test procedure if the variation of at least one parameter indicates a reduction of the sealing capability of the contact surfaces

In an embodiment, the surface parameter is derived from a three-dimensional surface topology measurement of the test surface. The three-dimensional topology measurement of the test surface may comprise providing a replica of the test surface by applying a body of deformable material to the test surface whereby the body of deformable material becomes an imprint of the test surface.

The method may comprise determining a material ratio curve of the test surface from the three-dimensional roughness measurement. Material ratio curves are for example used in the automotive industry to quantify the surface roughness of cylinder bores at various stages of running in. In such application, said at least one parameter may be selected from parameters Sₚₖ, Sᵥₖ, Sₖ, Vₘₚ, V_{mc}, V_{vc} and Vᵥᵥ of the test surface; wherein Sₚₖ is a reduced peak height, Sᵥₖ is a reduced valley depth, Sₖ is a core roughness depth, Vₘₚ is the material volume of the peak section, V_{vc} is the material volume of the core section, V_{vc} is the void volume of the core section, and Vᵥᵥ is the void volume of the reduced valley section.

Suitably said at least one parameter may comprise a friction factor for friction between the test surface and the counter surface. The variation of each parameter may comprise an increase of the friction factor indicative of galling between the test surface and the counter surface.

In another embodiment of the method, the representative test surface is provided by a sample that exhibits comparable material properties and/or surface topology as the selected surface on the connector. For example, the sample can be a flat metal strip of similar material as the connector material and machined with similar machining procedures as the metal-metal seal of the connector.

In another embodiment of the method, the load is applied to the test surface using a dedicated device or test set-up, which is specifically selected or designed to apply loads similar to the loads that occur on the connector surface during qualification testing.

In another embodiment, the test surface may be coated and/or lubricated during loading with substances suitable for OCTG connections. Examples of such substances are API compliant thread compound and Zinc-Phosphate coating.

The invention will be described hereinafter in more detail and by way of example, with reference to the accompanying drawings, in which:

FIG. 1 shows a longitudinal cross-section of an embodiment of a connector;

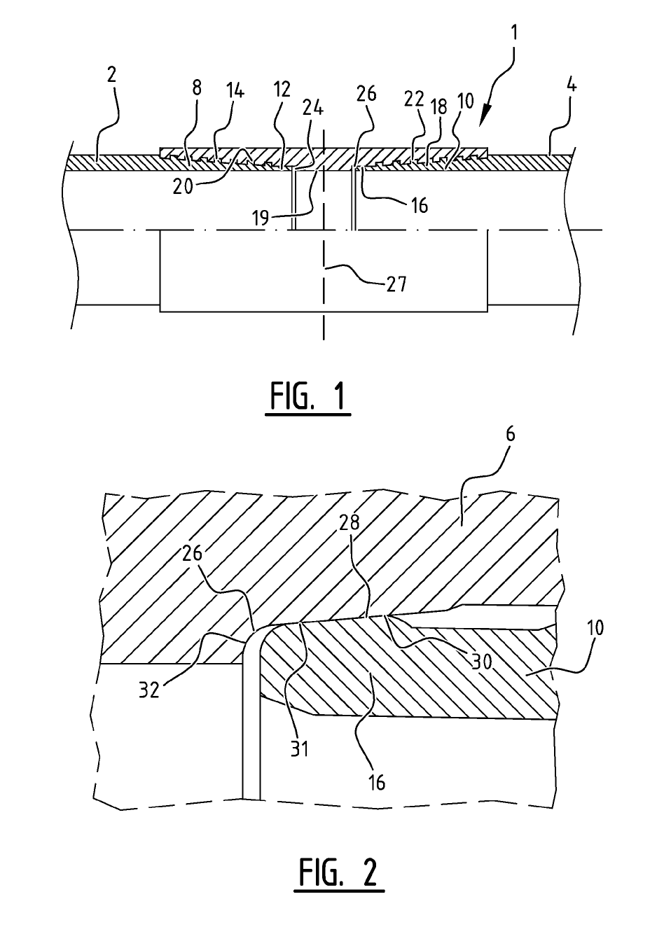

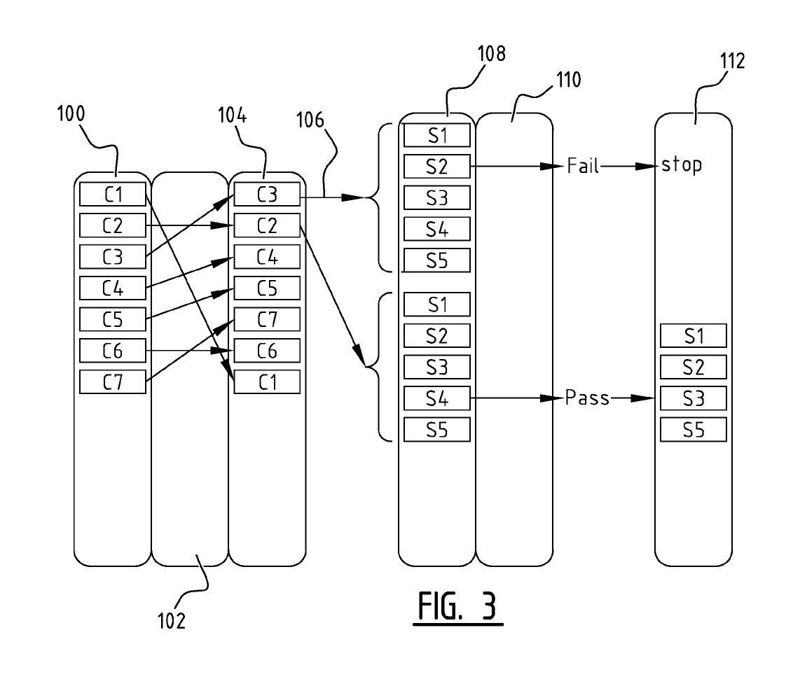

FIG. 2 shows a detail of an embodiment of a connector;

FIG. 3 shows an embodiment of a method of pre-selecting and subsequent qualification of connections according to the invention;

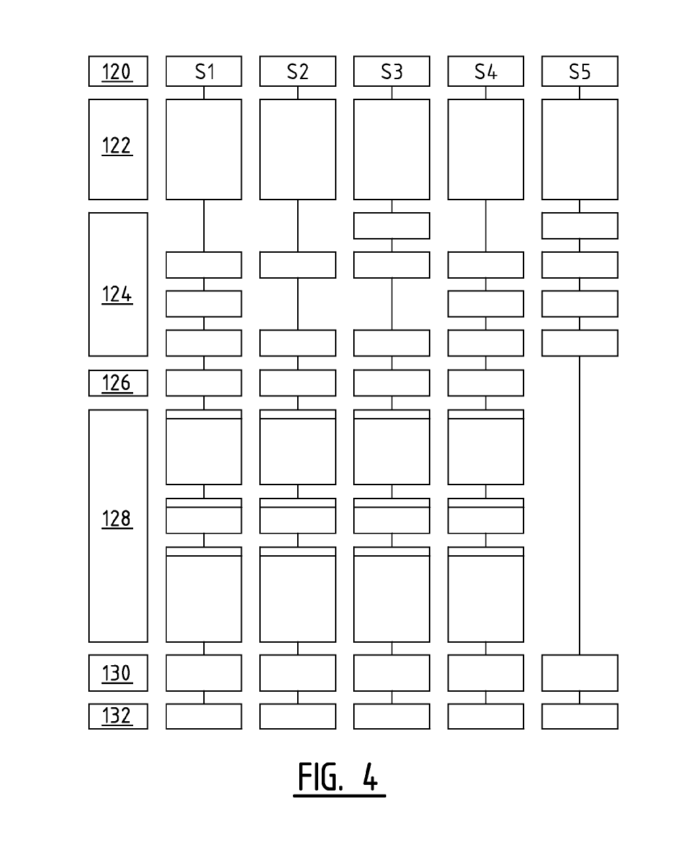

FIG. 4 shows a graphic representation of an exemplary qualification test protocol;

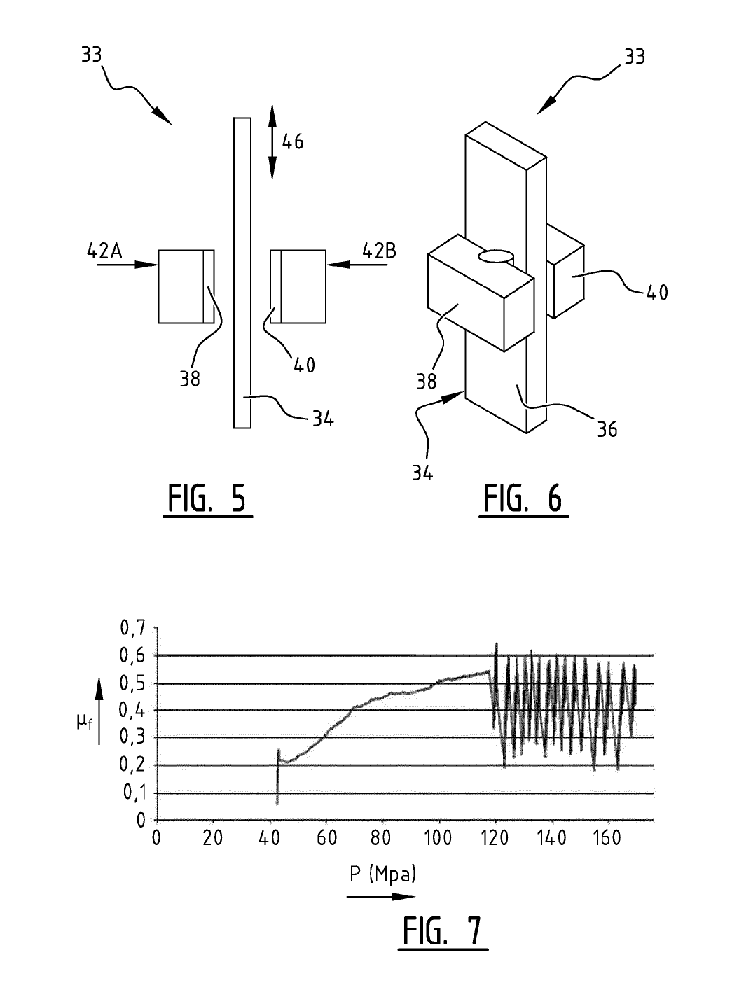

FIGS. 5 and 6 show examples of a tribometer;

FIG. 7 shows a diagram indicating friction factor versus compressive load between a test surface of a sample and a load element;

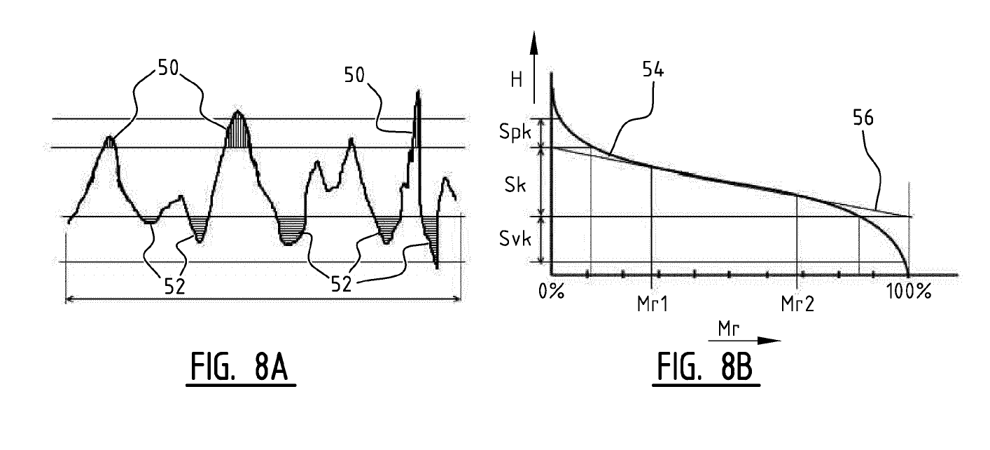

FIG. 8A shows a diagram of a surface profile of the test surface;

FIG. 8B shows an exemplary material ratio curve of the test surface;

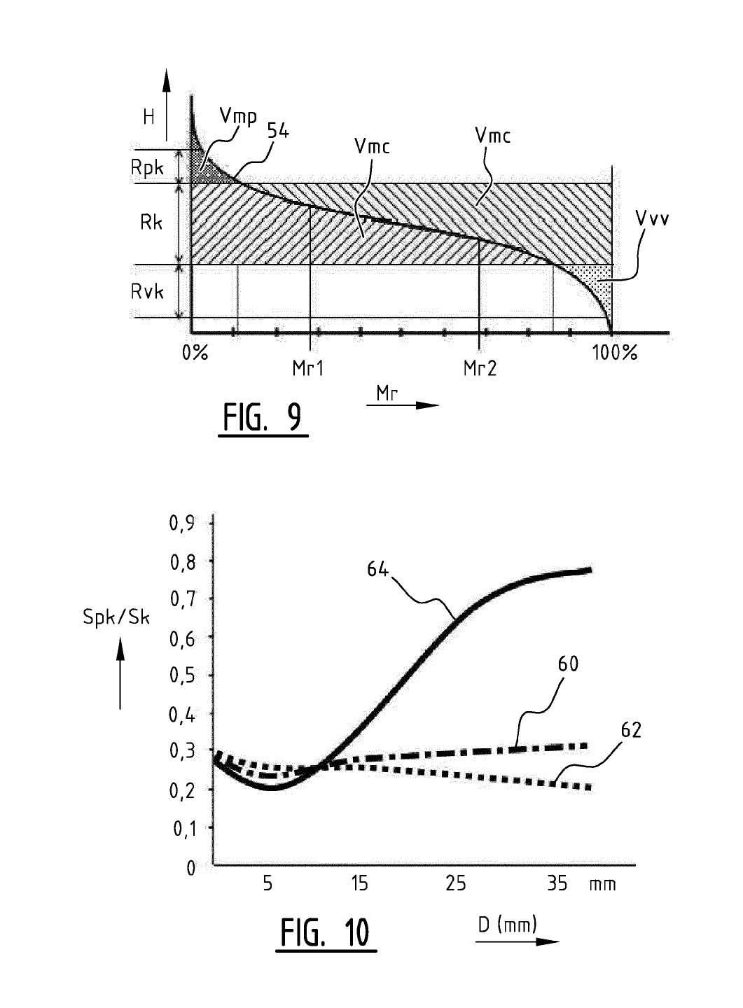

FIG. 9 shows an exemplary material ratio curve, indicating roughness volume parameters of the test surface; and

FIG. 10 shows a diagram indicating the ratio Sₚₖ/Sₖ of the test surface versus length of the sample.

Tubulars used in the oil and gas industry for the construction of oil and gas wells may be referred to as casing, liner or tubing, depending on the application. Such tubulars are typically semi-permanently installed in the wellbore for a number of reasons, such as:

i) Prevent collapse of the wall of the wellbore;

ii) Prevent formation fluids from entering the wellbore, at least from other zones than a hydrocarbon production zone;

iii) Prevent drilling fluid in the wellbore from entering the formation; and/or

iv) Provide sufficient collapse or burst strength to enable adequate well control operations, such as cap and contain operations.

The tubulars are designed to have a predetermined strength to be able to withstand a pressure difference between outside and inside the tubular without leakage of fluid or gas. The predetermined collapse and burst strength of the tubular may be based on pressure differences to which the tubular may be exposed. Said pressures may depend on the downhole conditions and loads that are expected during the lifetime of the well. The required strength of the tubular may be determined during a well design process.

Casing strings and liner strings typically have a length ranging from a few hundred feet to several thousands of feet (from about 100 m to several km). In order to construct casings of such length, pipe sections of, typically, approximately 30 to 40 ft (about 10 to 13 m) in length are joined by threaded connections. The connectors are made up on the drilling rig. An additional section of tubing is connected to the string which is already in the wellbore, and subsequently the tubular string, including the new section, is lowered into the wellbore until yet another pipe section can be added.

The connections to connect adjacent tube sections preferably meet the same strength and leak tightness requirements as the body of the pipe section. The requirements have been pre-determined during the well design process.

In order to objectively determine the strength and leak tightness of a connection, the oil industry has defined qualification test standards. During a qualification test, a set number of specially prepared test specimens—i.e. samples—of the respective connection are subjected to, for instance, a load, a sequence of loads, or particular combinations of loads.

The load may selected from external pressure, internal pressure, axial compression, axial tension, and/or bending up to a predetermined percentage of the design strength of the connector. The predetermined percentage is for instance in the range of 90% to 98%, for instance about 95%.

Testing may also include load cycling and/or temperature cycling. Cycling herein implies repeated application of, for instance, load or temperature, between two or more extremes. A lower temperature extreme may be room temperature or below. An upper temperature extreme may typically be about or exceed 180 degrees C. The load cycling may include repeated make-up and break-out of the connector, for instance at least 3 times make-up and break-out. Repeated make-up may expose a tendency of galling or thread damage.

An example of an industry standard for connector testing is ISO 13679.

Experimental testing of representative specimens for qualification is generally considered necessary. Theoretical predictions of sealing performance of the metal-to-metal seal in connections are typically insufficiently accurate to provide a reliable indication of the sealing performance.

A qualification of a connector is a costly and time consuming process. It is not uncommon that a qualification test for a new connector costs in the order of USD 500,000. In addition, the test may take up to a lot of time, for instance about 6 months of testing time, often in a dedicated laboratory. Consequently, the testing procedure may delay exploration and production of hydrocarbon resources, with associated loss of value.

Connection qualification testing is a continuous effort because:
new connection designs are regularly put on the market and require qualification;
regulations and qualification standards tend to change on a regular basis, requiring the test conditions to adapt to remain representative and cover changing well construction trends; and
regulations and qualification standards may change as part of the continuous effort to improve safety of drilling operations.

The present invention aims to improve the efficiency of a qualification test programme. The method generally is based on:
Pre-selecting connections that are most likely to pass a qualification test from a list of connections. If a confident pre-selection is made of connectors that are likely to pass the qualification, and these connections are tested with priority, this will result in an efficiency improvement of the programme because this will accelerate availability of qualified connections and no resources are consumed by testing connections that are unlikely to pass a qualification.
Providing a number, for instance 3 to 8, samples, and then selecting the sample which is most likely to fail the qualification test. The selected sample is tested first. If it fails the qualification, the test of the first ranked pre-selected connection ends, obviating the testing of the remaining samples. This minimizes effort and saves time. If the sample passes, the qualification test will be completed for the other specimens, but the chance that the first pre-selected connector passes the test is relatively high.

FIG. 1 shows a connector 1 for connecting two tubular elements 2, 4. The tubular elements are typically made of steel or a similar high-strength material.

In an embodiment, the connector 1 may comprise a box member 6. The bow member may be incorporated in a sleeve type element, the element having respective box members at opposite ends, as shown in FIG. 1. A first steel pin member 8 may be integrally formed with tubular element 2. A second steel pin member 10 may be integrally formed with tubular element 4. The box member 6 and the pin members 8, 10 are of tubular shape. The first pin member 8 has an end section 12 and a threaded outer surface 14 tapering radially inward towards the end section 12. Similarly, the second pin member 10 has an end section 16 and a threaded outer surface 18 tapering radially inward towards the end section 16. The box member 6 has an inner surface 19 with a first threaded portion 20 corresponding to the threaded outer surface 14. The corresponding threaded surfaces of the pin member and box member allow the tubular connector to be made up by screwing the pin member and the box member together.

The inner surface 19 of the box member may have annular recessed portions 24, 26 for receiving respective end sections 12, 16 of the pin members 8, 10 when the connector is assembled. Reference sign 27 indicates an axis of symmetry of the connector.

FIG. 2 shows the end section 16 of pin member 10 and the annular recessed portion 26 of the box member in more detail. The end section 16 has an outer contact surface 28 that seals against an inner contact surface 30 of the recessed portion 26 when the pin member 10 is fully inserted into the box member 6.

FIG. 3 shows an embodiment of a flow diagram of a qualification programme executed with optimized efficiency as enabled by the present invention.

In a first step, a list 100 is provided comprising a number of proposed connector designs C1, C2, . . . , C7, which have to be qualified.

In a second step 102, the connector designs C1 to C7 on the list 100 are ranked based on likelihood that each connector design will pass the qualification test. The connector designs are ranked in decreasing order of their likelihood to pass the test, providing a ranked list 104. A first ranked connector design C3 which is most likely to pass the qualification test is ranked first. The other connector designs are ranked in order of decreasing likelihood of passing the qualification test. I.e., a second connector design C2 which is second most likely to pass the test is ranked second, etc. The ranking can occur based on a method as described herein below.

Subsequently, the connector designs are tested, in the order of the ranked list 104. I.e., the first ranked design C3 which is most likely to pass is selected to be tested first.

In a next step 106, a number of test specimens S1 to S5 of the first ranked connector design C3 are produced. For instance two to ten samples are made, for instance about five samples. The samples S1 to S5 are produced at different combinations of extremes of machine tolerances. I.e., the samples will provide an overview of extremes of characteristics of the respective connector design, the characteristics including, for instance, leak-tightness, collapse strength, burst strength, etc.

In a first step 108 of testing a particular connector design, the specimens for said design are ranked based on their likelihood to fail the test protocol. A first ranked sample S2 which is most likely to fail the test will be tested first. A last ranked sample, which is most likely to pass the test, will be tested last. The other samples will be tested in between, in order of increasing likelihood that the respective sample will pass the test protocol.

Once the specimens S1 to S5 are ranked as described above, the first ranked specimen S2 will be subjected to the complete test in step 110. If the first ranked specimen S2 fails the test, the test will be finished, see step 112. The respective connector design will be removed from the test since one specimen did not pass. This will obviate the testing of the remaining, typically four, samples, also obviating the associated costs and time.

If the first ranked specimen S2 passes, the other samples S1 and S3 to S5 will be subjected to the same test sequence. Since the remaining samples are less likely to fail than the first sample, there is an increasing likelihood that these samples will also pass the qualification test, with the associated likelihood that the respective connector design will pass the test.

According to the method of the present invention, ranking of connector designs on the provided list and pre-selection can be performed by investigation of a seal surface, such as a metal-to-metal seal surface 28, 30 (FIG. 2), of a connector. The ranking based on the metal-to-metal seal surface can be replaced by investigating a representative sample of the metal-to-metal seal surface. The investigation can include measurement of one or more of:

i) the surface roughness of the seal surface before the representative sample of the connector is assembled;

ii) measurement of the roughness of the seal surface after the representative sample of the connector has been assembled; and/or

iii) subjecting the representative sample of the connector to load conditions that are representative for a load that the seal surface will experience during qualification testing, and subsequent measurement of roughness of the seal surface.

FIG. 4 shows an embodiment of a qualification protocol. In a first step 120, the protocol requires to provide a number of, for instance about five, connection test specimens S1 to S5.

As prescribed in second step 122, the test specimens are machined at various extreme combinations of, for instance, machining tolerances, interference of threads and/or seal surface, and taper of the pin member and the box member.

In step 124, the specimens S1 to S5 are subsequently subjected to repeated make-up and break out. Some specimens are made-up and broken out about three times, others are made-up and broken out two times. Make-up and break-out may be combined with prescribed extreme conditions, for instance minimum or maximum amounts of thread compound (e.g. lubricant), make-up torque, etc.

After each break-out, it is possible to perform non-destructive measurements of the test surface without interfering with the test protocol. In this manner, the variation, i.e. change, of one or more measured parameter values can be derived.

In step 126, a selected number of specimens, for instance specimens S1 to S4, may subsequently be subjected to application of load, to pressure cycling, and/or to temperature cycling to determine sealing performance before and/or after the test. The variation of difference between the measurements before and after the application of load provides an indication of the impact on the sealing performance. One of the specimens, for instance specimen S5, may only be subjected to limit load testing. Selection of the specimen that is most likely to fail the qualification test may be based on the value of a parameter describing the roughness of one or more of the seal surfaces.

Pre-selection and specimen selection can also be based on a relative change of the one or more seal surfaces before or after the surfaces have been subjected to a load.

Measurement of surface roughness and other relevant parameters can be carried-out using commercially available measurement devices. For example, the surface topology can be measured in three dimensions using interferometry. Optic microscopy can be used to inspect the surface and visually determine changes in roughness. Electron microscopy can be used to determine changes in roughness and measure material transfer from one surface to another surface. Friction can be measured using a tribometer.

To subject samples to a representative load, commercially available tribometers can be used.

FIGS. 5 and 6 show examples of a tribometer 33 for applying load to a sample. The sample may have the form of a flat strip 34. The strip 34 has a first surface 36 with material properties corresponding to the material properties of at least one of the contact surfaces 28, 30 (see FIG. 2) of a respective connector design, such as C1 to C7 (FIG. 3). For example, the first surface 36 has similar material properties as contact surface 28 of the pin member 8 of a selected connector.

The test apparatus 33 may comprise a pair of hardened anvil elements 38, 40 arranged opposite each other and movable towards each other. The test apparatus may for instance comprise a first actuator (not shown) for compressing the strip 34 between the anvil elements 38, 40. The actuator may be adapted to vary the magnitude of the compressive force between the anvil elements and the flat strip 34. The compressive force is indicated by reference signs 42A and 42B.

Furthermore, the apparatus 33 may be provided with a second actuator for moving the strip 34 with respect to the anvil elements 38, 40, wherein arrow 46 indicates a direction of movement. The movement may include reciprocating movement. The anvil elements 38, 40 may be made of, or comprise, for example, low carbon steel or stainless steel.

During use, the strip 34 is positioned between the anvil elements 38, 40. The test surface 36 faces anvil element 38. The first actuator compresses the strip 34 between the anvil elements. Simultaneously, the second actuator may be operated to move the strip with respect to the anvil elements.

Compressive stress between the strip 34 and the respective anvil elements may be gradually increased to a maximum compressive stress, corresponding to a compressive stress between the contact surfaces 28, 30 of the connector 1 (FIG. 2) as expected during the qualification test procedure.

Several methods allow to determine changes or variation of material properties of the surface 36 of the strip 34. For instance, as a start, the surface 36 may be visually inspected for signs of galling. Herein, galling refers to cold welding between small portions of surface 36 and anvil element 38 due to compressive stresses, which may locally exceed a threshold for welding, followed by rupturing of the welded portions due to continued sliding of the surface 36 along the anvil element 38. Galling would cause the surface to become increasingly irregularly shaped.

FIG. 7 shows a diagram of a friction factor (μ_{f}) for friction between the surface 36 and anvil element 38, versus compressive stress (P) between the surface 36 and the anvil element 38. Initially, on the left side of the diagram, the friction factor increases slightly with increasing compressive stress, which may be due to squeezing out of some lubrication material between the surface 36 and the anvil element 38. However, when the compressive stress exceeds a certain galling galling threshold level P1, for instance about 120 MPa, the friction factor typically starts to fluctuate significantly. The latter indicates the occurrence of galling between the surface 36 and anvil element 38. Excessive galling will render the surface 36 unsuitable for operational use in view of the risk of leakage of liquid or gas between the contact surfaces 28, 30 of the connector 1.

In accordance with an embodiment of the method of the present invention, the qualification test procedure of the respective connector design will be ceased if the galling threshold level P1 is equal to or lower than a maximum contact pressure which is expected during either the test procedure and/or during operational use in hydrocarbon production applications. If P1 exceeds the expected said maximum expected contact pressure, the test procedure will be continued.

FIG. 8A shows, at an enlarged scale, a length L of a surface profile of a test surface 36 at a selected stage of testing with the apparatus 33. The test surface has a core section of thickness Sₖ, a peak section of thickness Sₚₖ above the core section, and a valley section of thickness Sᵥₖ below the core section. The peak section has material volume portions 50, and the valley section has void volume portions 52.

FIG. 8B shows an example material ratio curve 54 of the test surface of the surface 36 at the selected testing stage. FIGS. 8A and 8B share vertical axis H indicating the height of a point on the test surface relative to a reference height. The reference height may be the best fitting least squares mean plane of the test surface.

The horizontal axis of FIG. 8B indicates the ratio Mr of cross-sectional area of the test surface at height H relative to the cross-sectional area of the evaluation length at a height of 100% material (i.e. below the deepest valley), expressed as a percentage. Mr may also be referred to as “Percent data cut”.

Prior to establishing the material ratio curve, a certain percentage of the peak points (referred to as the Peak Offset) and valley points (referred to as the Valley Offset) may be ignored to minimize the effects of outliers.

Typically the Peak Offset and Valley Offset may be set to about 1%. The core section Sₖ is determined from the secant of the material ratio curve in the 40% section of the horizontal axis with the lowest gradient.

In the example of FIG. 8B, the secant is indicated by reference sign 56. The 40% section extends between Mr1 and Mr2 on the horizontal axis. The core section Sₖ extends between the height where the secant 56 crosses the vertical axis at Mr =0% and the height where the secant 56 crosses the vertical axis at Mr =100%. The peak section Sₚₖ extends from the core section Sₖ to the highest peak less the Peak Offset, and the valley section extends from the core section Sₖ to the deepest valley less the Valley Offset.

FIG. 9 shows the material ratio curve with shaded areas Vₘₚ, V_{mc}, V_{vc} and Vᵥᵥ indicated. Herein, Vₘₚ is a measure for the material volume of the peak section. V_{mc} is a measure for the material volume of the core section. V_{vc} is a measure for the void volume of the core section. Vᵥᵥ is a measure for the void volume of the valley section. For example, the material volume of the peak section may be determined by determining the area Vₘₚ from the material ratio curve, and multiplying Vₘₚ by the cross-sectional area of the evaluation sample length.

A change of any of the parameters Sₚₖ/Sₖ, Sᵥₖ/Sₖ, V_{vc} or Vᵥᵥ after subjecting the test surface to the load may indicate an increased risk of fluid leaking past the metal-to-metal contact surfaces of the connector. Namely, an increase of Sₚₖ/Sₖ or Sᵥₖ/Sₖ may indicate the occurrence of galling between a coated layer on test surface 36 and anvil element 38. An increase of V_{vc} or Vᵥᵥ may indicate a volume increase of fluid channels in the test surface 36.

In an embodiment of the method of the invention, the parameters Sₚₖ/Sₖ, Sᵥₖ/Sₖ, V_{vc} and/or Vᵥᵥ are determined from the material ratio curve of the test surface. These parameters are optionally measured or determined both before and after subjecting the test surface 36 to the load. The qualification test procedure of the connector 1 may be ceased if at least one of ratio Sₚₖ/Sₖ, ratio Sᵥₖ/Sₖ, V_{vc} and Vᵥᵥ has changed unfavourably after subjecting the test surface to the load. Conversely, if there is no significant change of each of Sₚₖ/Sₖ, Sᵥₖ/Sₖ, V_{vc} and Vᵥᵥ after subjecting the test surface to the load, the qualification test procedure of the connector will be continued. Herein, the qualification of “significant change” of each of Sₚₖ/Sₖ, Sᵥₖ/Sₖ, V_{vc} and Vᵥᵥ may be determined relative to a pre-determined threshold or safe level.

FIG. 10 shows an example of a diagram of Sₚₖ/Sₖ versus distance of movement D of the strip 34 along anvil element 38. Herein, the compressive stress between the surface 36 and the anvil element 38 is increased with distance of movement. Lines 60, 62 refer to test results whereby lubrication material is present between the strip 34 and the anvil element 38 during testing. Herein, the ratio Sₚₖ/Sₖ does not increase with distance of movement. Line 64 refers to a test result whereby no lubrication material is present between the flat strip 34 and the anvil element 38 during testing. Herein, the ratio Sₚₖ/Sₖ increases with distance of movement. In the situation of line 64, galling has occurred between the contact surfaces. In accordance with the method of the invention, in the event of line 64 it was decided to stop the test and not to proceed with qualification testing of the connector, as the level of galling exceeded an acceptance threshold.

The method of the present inventions improves the efficiency of a connection test programme. This will result, for instance, in the following advantages:
Less time is spent for qualification which will lead to accelerated availability of connectors for drilling operations. In certain cases, this can result in earlier delivery of oil or gas wells which has a significant economic advantage
Less resources are spent on a qualification test, which is a direct cost saving. It is noted that the qualification test usually does not stipulate the most efficient manner to obtain a ‘pass’ or a ‘fail’ qualification test result.

The present invention is not limited to the embodiments as described above, wherein various modifications are conceivable within the scope of the appended claims. Features of different embodiments may for instance be combined.

1. A method for qualification testing of a tubular connector for a hydrocarbon fluid production application, the tubular connector comprising a sealing surface, the method comprising the steps of:
selecting a test surface representative of the sealing surface of the tubular connector;
selecting at least one surface parameter;
measuring the at least one surface parameter on the test surface;
assessing a sealing performance of the sealing surface based on the measured at least one parameter; and
deciding to cease qualification testing of the tubular connector if the assessment is unfavourable.

2. The method of claim 1, comprising an additional step of deciding to subject the tubular connector to qualification testing if the assessment is favourable.

3. The method of claim 1, wherein the step of measuring the at least one surface parameter comprises:
subjecting the test surface to load conditions representative for conditions occurring during the qualification test procedure; and
measuring the at least one surface parameter on the test surface after the test surface has been subjected to the load conditions.

3. The method of claim 2, wherein the at least one surface parameter is measured before and after the test surface is subjected to load conditions occurring during qualification testing.

4. The method of claim 3, wherein assessing a sealing performance is based on a variation of the at least one surface parameter, the variation being the difference between the pre-value of the at least one surface parameter before the test surface is subjected to load conditions and the post-value of the at least one surface parameter after the test surface is subjected to load conditions.

5. The method of claim 1, wherein the qualification testing is in accordance with -industry standard ISO-13679.

6. (canceled)

7. The method of claim 1, wherein the at least one surface parameter comprises surface roughness (Spk).

8. A method for qualification testing of a tubular connector for a hydrocarbon fluid production application, the method comprising the steps of:
providing at least two test samples of the tubular connector;
selecting a test surface on the at least two test samples;
selecting at least one surface parameter;
measuring the at least one surface parameter on the test surface of each of the at least two test samples;
assessing a sealing performance of the test surfaces of the at least two test samples based on the measured surface parameters of each of the at least two test samples;
selecting an initial test sample of the at least two test samples, the initial test sample having a test surface that is least likely to seal; and
commencing the qualification testing with the initial test sample.

9. The method of claim 8, wherein the step of measuring the at least one surface parameter comprises measuring the at least one surface parameter before commencing the qualification testing and/or after application of a load.

10. (canceled)

11. The method of claim 8, comprising the step of determining a variation of the at least one surface parameter, the variation being the difference between a measured value of the at least one surface parameter before and after application of a load.

12. The method of claim 11, wherein the step of assessing the sealing performance comprises and assessment based on the variation of the at least one surface parameter.

13. The method of claim 9, wherein application of a load comprises subjecting the test surface to conditions representing qualification testing.

14. The method of claim 8, wherein the at least one surface parameter comprises roughness (Spk).

15. The method of claim 8, wherein the step of measuring the at least one surface parameter comprises measuring the at least one surface parameter at various stages of completion of the qualification testing.

16. A method of selecting a tubular connector for qualification testing for a hydrocarbon fluid production application, the connector including a first connector member and a second connector member being adapted to be engaged to each other whereby a first contact surface and a second contact surface of the first connector member and the second connector member respectively are in sealing contact with each other, the method comprising the steps of:
providing a test surface selected from one of said first contact surface and second contact surface,
determining at least one parameter of the test surface relating to the sealing capability of the contact surface;
subjecting the test surface to a load, the load corresponding to a selected phase of a qualification test procedure for the tubular connector;
removing the load;
determining a variation of the at least one parameter; and
ceasing the qualification test procedure if the variation of at least one parameter indicates a reduction of the sealing capability of the contact surfaces.

17. The method of claim 16, comprising the step of:
proceeding with the qualification test procedure of the connector if, for each at least one parameter, the variation of the at least one parameter does not indicate a reduction of the sealing capability of the first contact surface and the second contact surface.

17. (canceled)

18. The method of claim 31, wherein the counter surface is selected from a surface of low carbon steel and a surface of stainless steel.

19. The method of claim 31, wherein the counter surface includes a surface of an anvil element, and wherein the step of subjecting the test surface to a load comprises moving the test surface relative to the surface of the anvil element.

20. The method of claim 19, including the step of gradually increasing a compressive force between the test surface and the surface of the anvil element.

21. The method of claim 19, comprising wherein moving the test surface relative to the surface of the anvil element in a reciprocating manner

22. The method of claim 16, wherein the test surface is a surface of a flat metal strip.

23. The method of claim 16, wherein the at least one parameter comprises a friction factor indicative of friction and/or galling between the test surface and a counter surface.

24. (canceled)

25. The method of claim 16, comprising a step of determining the at least one parameter from a three-dimensional roughness measurement of the test surface.

26. The method of claim 25, wherein the step of measuring the three-dimensional roughness of the test surface comprises providing a replica of the test surface.

27. The method of claim 26, wherein providing a replica of the test surface comprises the step of applying a body of deformable material to the test surface, whereby the body of deformable material assumes a profile complementary to a profile of the test surface.

28. The method of claim 25, further comprising determining a material ratio curve of the test surface from the three-dimensional roughness measurement.

29. The method of claim 16, wherein the at least one parameter is selected from the group of: Sₚₖ, Sᵥₖ, Sₖ, Vₘₚ, V_{mc}, V_{vc} and Vᵥᵥ of the test surface, wherein Sₚₖ is a reduced peak height, Sᵥₖ is a reduced valley depth, Sₖ is a core roughness depth, Vₘₚ is the material volume of the peak section, V_{mc} is the material volume of the core section, V_{vc} is the void volume of the core section, and Vᵥᵥ is the void volume of the reduced valley section.

30. The method of claim 16, the variation of at least one parameter indicates a reduction of the sealing capability of the contact surfaces if at least one of V_{vc}, Vᵥᵥ, the ratio Sₚₖ/Sₖ and the ratio Sᵥₖ/Sₖ has increased after subjecting the test surface to the load.

31. The method of claim 16, wherein the step of subjecting the test surface to a load comprises moving the test surface along a counter surface and in compressive contact therewith.
